(19) United States
(12) Patent Application Publication
(10) Pub. No.: US 2014/0207791 A1
(43) Pub. Date: Jul. 24, 2014

(54) INFORMATION NETWORK FRAMEWORK FOR FEATURE SELECTION FIELD

(71) Applicant: ADOBE SYSTEMS INCORPORATED, San Jose, CA (US)

(72) Inventors: Marina Danilevsky, Mountain View, IL (US); Eunyee Koh, San Jose, CA (US)

(21) Appl. No.: 13/746,582

(22) Filed: Jan. 22, 2013

(51) Int. Cl. G06F 17/30

(52) U.S. Cl. CPC G06F 17/3053
USPC 707/748

(57) ABSTRACT

Systems and methods are disclosed to facilitate real time feature selection. Some embodiments of the invention describe a framework for feature selection via an iterative probabilistic graph learning approach. A feature dataset can be collected and transformed into an information network in a star schema layout, respecting feature type differences. Features can then be simultaneously ranked in the network, both with respect to feature types and the central feature. Feature selection is then performed, allowing for both the identification of valuable features, and, if dealing with labeled data, the ability to construct predictive rules for future data records based on the ranked and selected feature set.

### FIELD

This disclosure relates generally to feature selection and/or prediction in a network framework. In particular, the present invention relates to predicting webpage features that will result in a high advertisement conversion rate.

### BACKGROUND

Feature selection concerns the problem of selecting a subset of important features from a potentially large amount of features in order to build a predictive model. One real world example of this problem is the advertising display problem. For example, a marketer may wish to place an advertisement from among a pool of possible ads on a webpage, but wishes to place the advertisement on the webpage that can provide the highest probability that a user will actually click on the advertisement. The marketer may base the placement of the advertisement on any number or type of previous observations or features of webpages and/or advertisements.

Many approaches to feature selection are univariate, which assumes each feature to be completely unrelated to any other features. This assumption often does not reflect the true characteristics of real world data, where features may actually be correlated with one another. The relationship between label features (e.g., advertisement conversion features) may also be multivariate, meaning that the label's value may be more effectively modeled based on the joint values of several features, than the values of each feature independently. The feature-label relationship may also be nonlinear, or noisy. Finally, the feature set may be of mixed type (e.g. both numerical and categorical), may contain many missing values, and be of very high dimensionality. These characteristics, which are often present in real world data, may restrict the types of feature selection methods which are possible to use.

### SUMMARY

Embodiments according to the present disclosure provide methods and systems for organizing a dataset of records. Each record can include feature values organized by feature type and a value related to the conversion of an advertisement. A mathematical metric between at least one feature type and the conversion of the advertisement can be calculated. The feature values can be ranked for at least one feature type based on the mathematical metric. The informative feature types from the ranking of feature values can be identified. A recommended advertisement can be provided based on the informative feature types.

Embodiments according to the present disclosure provide methods and systems for feature selection. In some embodiments, feature selection can include organizing a dataset of feature values, wherein the dataset includes a plurality of values representing features for a plurality of users accessing a network resource. A plurality of features can be defined as vertices of a star schema and at least one feature as the central feature. A plurality of edges between related feature values within the dataset can be defined based on some metric. Then the features can be ranked with respect to feature type based on the edges. A model that correlates the probability of the central feature existing based on the vertices of the star schema using the ranking can be provided.

In some embodiments, the star scheme includes one or more features organized as a central feature. In some embodiments, a weight of each edge can be determined and/or used as part of the ranking. In some embodiments the features can comprise nominal features, continuous features, and/or prefix features.

In some embodiments the central feature can comprise an advertisement and wherein at least one feature is the conversion rate of the advertisement. In some embodiments an edge between the advertisement and the conversion rate is the lift. In some embodiments a plurality of features of a given feature type can be filtered based on the weight of the edge.

In some embodiments, feature selection can be accomplished using a computing system comprising a processor, a database, and a non-transitory computer-readable medium that includes program components. The database can store a dataset that includes a plurality of values representing features for a plurality of users accessing a network resource. The program code can embody program components that perform the steps of defining a plurality of features in the dataset as vertices of a star schema and at least one feature as the central feature; defining a plurality of edges between related feature values within the dataset; ranking features with respect to feature type based on the edges; and providing a model that correlates the probability of the central feature existing based on the vertices of the star schema using the ranking.

In some embodiments, feature selection can be accomplished with a computer program product that includes a non-transitory computer-readable medium embodying code that can be executable by a computing system. The program code can organize a dataset of feature values. The dataset can include a plurality of values representing features for a plurality of users accessing a network resource. The program code can define a plurality of features as vertices of a star schema and at least one feature as the central feature. The program code can define a plurality of edges between related feature values within the dataset. The program code can rank features with respect to feature type based on the edges. The program code can provide a model that correlates the probability of the central feature existing based on the vertices of the star schema using the ranking.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 shows an example of a dataset that can be used in embodiments of the invention.

FIG. 2 is a block diagram of a star schema according to some embodiments of the invention.

FIG. 3 shows a block diagram of a system for determining webpage features that are related to a high conversion probability according to some embodiments of the invention.

FIG. 4 is a flowchart of a process for developing a predictive model for feature selection according to some embodiments of the invention.

FIG. 5 is a flowchart of a process for developing a predictive model for feature selection according to some embodiments of the invention.

FIG. 6 shows the block diagram shown in FIG. 2 with an additional feature according to some embodiments of the invention.

FIG. 7 shows the block diagram of FIG. 6 with weights, λ, shown for each edge according to some embodiments of the invention.

FIG. 8 shows an example of a computational system that can be used to perform some embodiments of the invention.

### DETAILED DESCRIPTION

Systems and methods are disclosed to facilitate real time feature selection. Feature selection solves the problem of selecting a subset of important features from a potentially large amount of features in order to build an accurate model. This can be useful for associating certain website features, e.g., keywords, fonts, colors, etc., with the success of an advertisement. Similarly, it can be useful for associating features of website viewers, e.g., user age, location, time of day, etc., with the success of an advertisement, Such associations can be used to determine on which websites, to which users, and in which viewing conditions particular advertisement should be displayed to improve the chances that those future uses of those advertisements will be successful. In other words, it can be helpful to know the website and/or user features that produce the highest conversion (or click through) for a given advertisement. For example, embodiments of the invention can be used to discover webpage features that result in the highest rate of selection for advertisements on the webpage. By using log data from various webpages having a similar or the same advertisement, embodiments of the invention can be used for advertisement placement. A feature can include data related to a user's interaction with a webpage such as, for example, data related to the user, the user's location, the specific webpage, the time of day, day of the year, etc. A number of specific features are described below.

Embodiments of the invention can be used to correlate webpage and/or user features based on feature type with each advertisement in a group of advertisements. Using this data and the specific features of a webpage and/or user, an advertisement can be selected from the group of advertisements when a specific webpage is requested by a specific user. In this way, advertisements with the highest likelihood of conversion can be presented based on the webpage, user, and/or circumstances.

To identify features associated with a given advertisement an iterative probabilistic graph learning technique can be used. A feature dataset can be collected and transformed into an information network (e.g., a star schema) that respects feature type differences yet maintains correlation between features. Features may then be ranked (possibly simultaneously) in the network, both with respect to feature types and the central feature (e.g., an advertisement). Feature selection is then performed, allowing for both the identification of valuable features, and/or the ability to construct predictive rules for future data records based on the ranked and selected feature set.

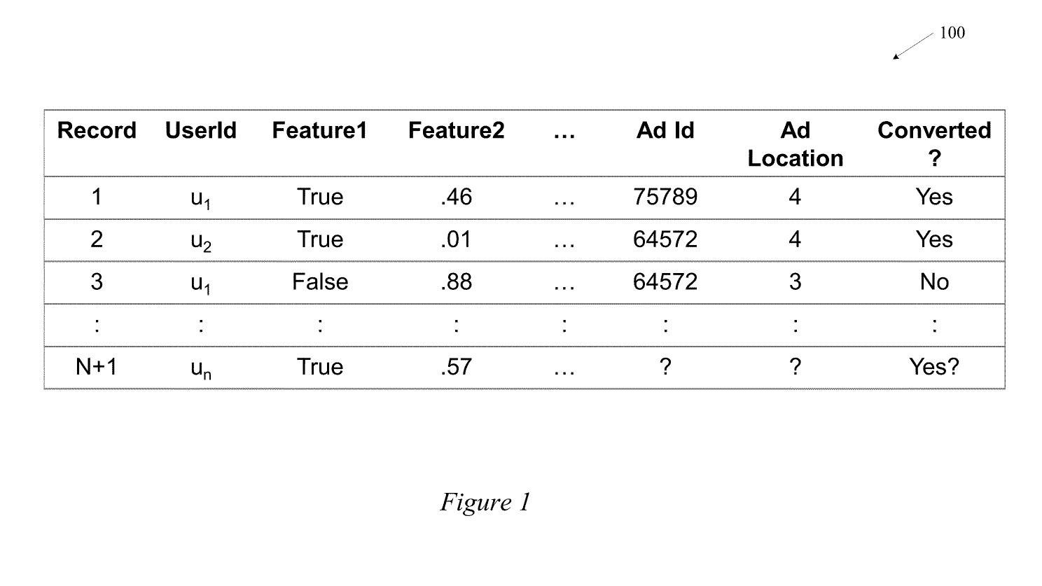

FIG. 1 is an example of a dataset that includes observation information relating the use of certain webpage features (including webpage ads use) and advertisement conversion information. The rows in the dataset are observations. Each observation can be a vector of different observed values for the observed features. An observation can include a value for each feature observed along with other identifying information such as labels and/or identifiers (e.g., record number, userId, Ad Id., Ad location, etc.).

In the context of the webpage features of this example, feature types can include features related to the webpage and/or the user interaction with the webpage and can include information about the use of advertisements in the webpage. A number of examples of webpage features are described below. An observation in the webpage context can also include conversion data that indicates whether a user viewing an advertisement associated with advertisement identifier (Ad Id) took a desired action (e.g., clicked on the ad). Conversion refers to the completion of the desired action. For example, the conversion rate for an advertisement on a webpage may represent the percentage of the total visitors of the webpage that click on the advertisement.

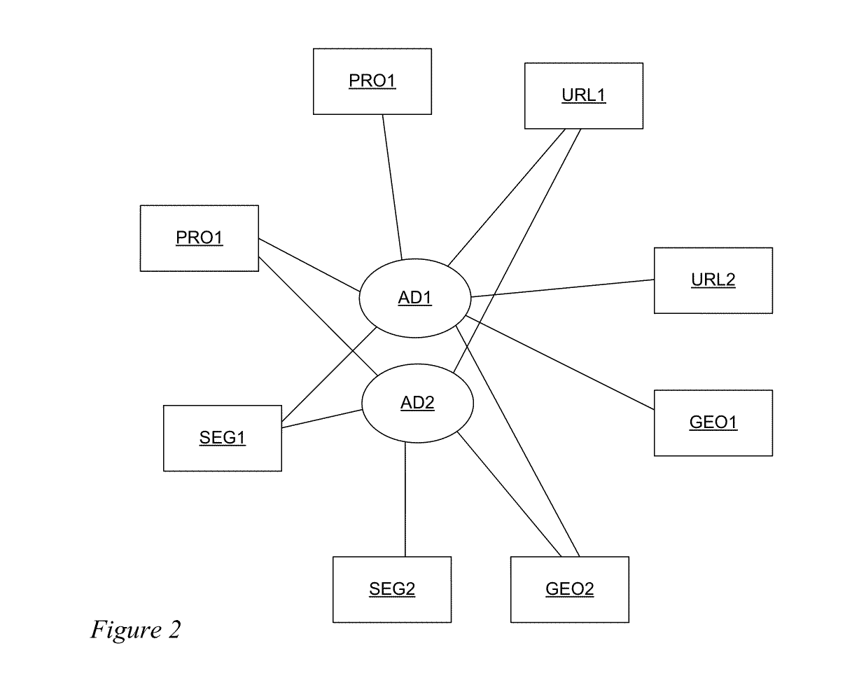

The dataset can be represented graphically in a star schema as shown in FIG. 2. In this example, two advertisements (AD1 and AD2) are positioned in the center of the star schema with other features arranged as vertices. Each advertisement can be considered a central feature, and/or a label feature in a classification problem. The links (or edges) define a relationship between the central feature and various features at the edges using a mathematical metric. In this example, the connections between various features GEO1, GEO2, PRO1, PRO2, URL1, URL2, SEG1 and SEG2 are linked with advertisements AD1 and AD2.

The term “mathematical metric” is used herein to refer to anything that defines a mathematical relationship between a distinct pair of feature types. The links between features and advertisements can be a mathematical metric that relates the feature with the advertisement. For example, the mathematical metric can be the co-occurrence, correlation, Euclidan distance, or cosine similarity of the feature and the conversion of the advertisement as described in more detail below.

Once the data set has been organized and graphically linked together, features can be ranked based on feature type and features related to a high conversion can be returned. This ranking is described in more detail below.

In a broader sense, embodiments of the invention are directed toward feature selection in a network framework. While the example of determining advertisement conversion probabilities based on webpage features is used throughout this disclosure, embodiments of the invention may be used in many other applications.

Returning to FIG. 1, dataset 100 can include a number of different labels and/or feature types. For example, the dataset can include UserID, which may be a unique identifier of a user of a webpage. In some embodiments it can be assumed that each user is unique. With this assumption, the user related values can be ignored.

In some embodiments, the dataset can include various data values (or features) of user visits to a given webpage with an advertisement. The columns represent feature types and the rows represent observations. Not every observation will include values corresponding with every feature type.

In this example, the dataset includes a row of data for each user. The columns of data in the dataset represent various data elements and/or features. The columns can include, for example, the record number and the user id of the user visiting the webpage with the advertisement. Any number of columns can include values for various features. In this example, Feature1 is a binary feature that can be represented by “TRUE” or “FALSE” values. For example, Feature1 can include a true or false value based on whether the user is accessing the webpage using a handheld device. Feature2 is a continuous feature and may be represented by any number; for example, the amount of time the user spends on the webpage. Other columns can include data representative of other features.

The data set can include columns that represent an identifier of a specific advertisement. These identifiers identify the advertisement presented to the user associated with the user id and with the features noted in the other columns. The advertisement location can also be included along with data noting whether the advertisement was converted (or clicked through).

Various other datasets can be used. Indeed, the dataset shown in FIG. 1 is merely a representation of a dataset that can be used in embodiments of the invention. Some other data may be included and other data may be excluded. The dataset may vary depending on the type of web server, client needs, the type of advertisement, etc.

In some embodiments feature values can include nominal features. A nominal feature can be a feature that has a categorical value that cannot be compared with other values; for example, zip code, browser type, etc. In some embodiments the top N most common values can be used and the others ignored, where N can include any integer. For example, N can equal 5, 10, 15 or 20. Continuous features have numerical values that can be compared; for example, time values, dates, etc. In some embodiments continuous feature values can be scaled to a consistent range, for example, to a value between zero and one.

Features can also be client device specific and/or domain specific. For example, features for a document network such as any collection of documents can include, for example, the title, author, number of pages, keywords, year of publication, etc.

Prefix features can include a number of features defined by various variable prefixes. Any number and/or type of prefix features can be used. A number of examples of prefix features are described herein. Geolocation features (GEO), for example, can include information such as the user's country, state, city, zip, region, etc. The values added to this column can include zip codes, states, regions, countries, etc. Environment features (ENV) can include, for example, parameters related to the user's environment (user screen resolution and/or size, web browser type, user color depth, web browser version, operating system version, etc.). Profile script features (PRO), for example, can include parameters generated by profile scripts, created by a client. Segment features (SEG), for example, can describe segment allocation of client create segments. URL features (URL), for example, can include parameters coming from an http request (&music=pop->URL_music=pop). Referral URL features (REF) can include parameters of the referring URL.

Other features can include time features (e.g., time of day, day of the month, month, year, etc.), type of page or host (e.g., news, blog, commerce, government, etc.) holiday information, etc. Other features can include information provided, for example, by Google Analytics™, and/or other Internet Access Control (IAC) information.

The type and/or number of features are limitless. Indeed, any type of feature can be used. Moreover the number and/or type of client defined featured can evolve through use. Client defined features can include, for example, phrases usage, words usage, keyword information, type of sport, a hobby type, subject matter, etc.

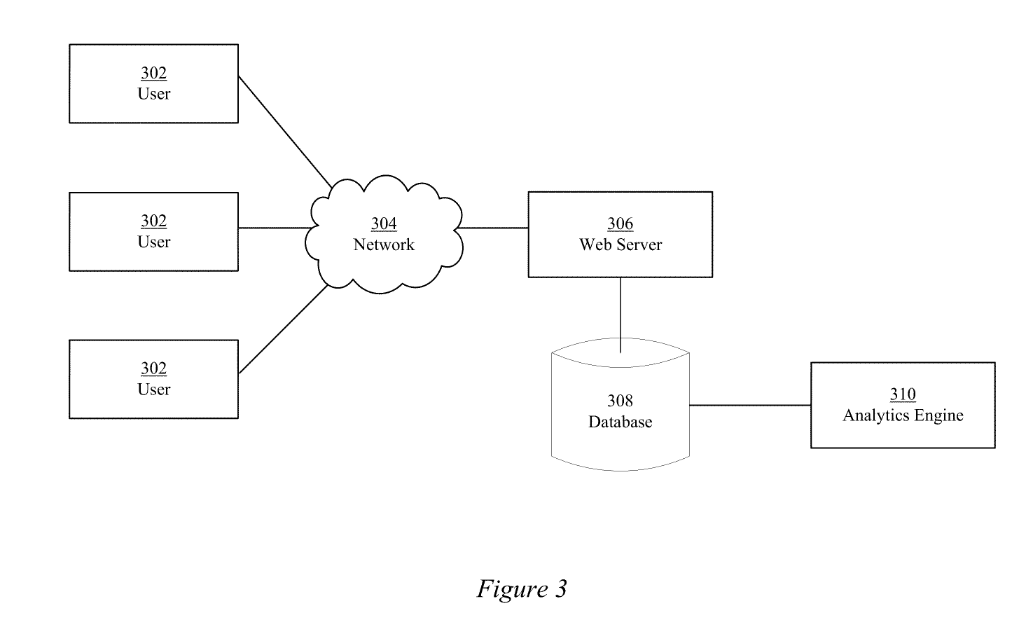

FIG. 3 shows a block diagram of a network system that can be used for embodiments of the invention. For example, the network system can be used to determine webpage features that are related to ads that have a high conversion probability. Web server 306 hosts a webpage. Webserver 306 can be a single server, a plurality of servers, a plurality of distributed servers, and/or a plurality of servers spread across a network cloud. One or more webpages can be hosted at webserver 306. These webpages can include content hosted at web server 306 and/or content from various other distributed servers. The content can include advertisements provided and/or hosted by third parties.

A plurality of users 302 can access webserver 306 through network 304. Users 302 can access webserver 306 using any type of digital device that includes web browsing capabilities. These devices can include, for example, a desktop computer, laptop computer, a tablet computer, a smart phone, etc. Data related to the user can be collected at webserver 306.

Webserver 306 can be communicatively coupled with database 308. Database 308 can be used to store and/or log data collected at webserver 306. This data, for example, can be related to the webpages hosted at webserver 306. Database 308, for example, can store features of the webpage. These features can include the features described herein as well as any other feature or data related to the webpage. Moreover, database 308 may store data in a dataset, for example, like the one shown in FIG. 1.

Analytics engine 310 can be coupled with database 308. Analytics engine 310 can be used to analyze the data stored in database 308. Embodiments of the invention describe various examples of process, algorithms, and/or methods that can be executed by the analytics engine when analyzing the data.

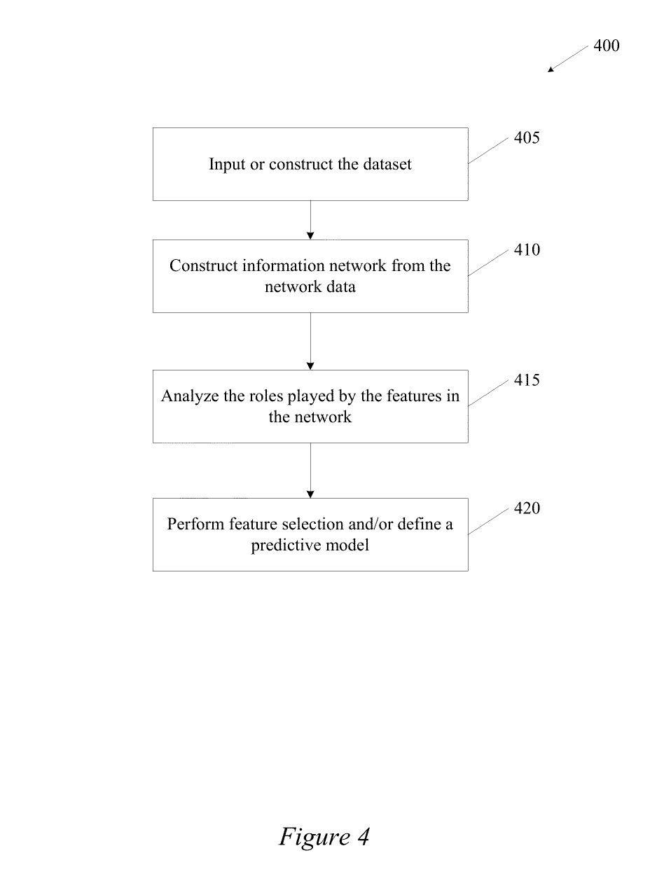

FIG. 4 is a flowchart of process 400 for developing a predictive model for feature selection according to some embodiments of the invention. This process can be used, for example, to select features that are related to advertisements that have a high conversion rate. Process 400 begins at block 405 where a dataset can be input or constructed. The dataset can include, for example, dataset 100 shown in FIG. 1. For example, network data can be input from database 308 into analytics engine 310.

At block 410 an information network can be constructed from the data. In some embodiments this construction can link data features together. For example, various data types can be linked and analyzed with an advertisement id. In some embodiments the features can be organized in a star schema where features are the vertices of the star and labels are the center as shown in FIG. 2. Links between features and/or labels can be established and a mathematical graph representing the relationship of the data can be developed.

At block 415 the roles played by the features in the data can be analyzed. The data is analyzed knowing a number of intuitions about the data. In some embodiments it can be assumed that knowing that the higher a feature is ranked within a given advertisement the more closely tied the feature is with the advertisement or a group of related ads relative to other features. In some embodiments it may be assumed that data is noisy and/or sparse, which may lead to only using top-ranked features. In some embodiments some features are trusted more than others. For example, client requested features may have more value than other features.

At block 420 feature selection may be performed and/or a predictive model defined according to some embodiments of the invention. The predictive model can assume, for example, that if a user is served an advertisement associated with such features they will be more likely to click on the advertisement if the user and/or webpage exhibit more of the highly ranked features for this advertisement.

In some embodiments the predictive model can create rules for future ad serving needs. For example, embodiments of the invention can help marketers generate more conversion for their ads by providing information to more strategically place ads and/or can create more revenue for webpage owners by selling advertisement space with a higher likelihood of conversion. For example, the predictive model can associate each advertisement in a set of advertisements with features that produce a high probability of advertisement conversion. Then, when a user visits a webpage an advertisement that has the highest probability for conversion can be selected from the set of advertisements using the webpage and/or user features. This can be done, for example, in real-time, which can allow the marketer to place an ad based on the unique features of a specific webpage and/or specific user.

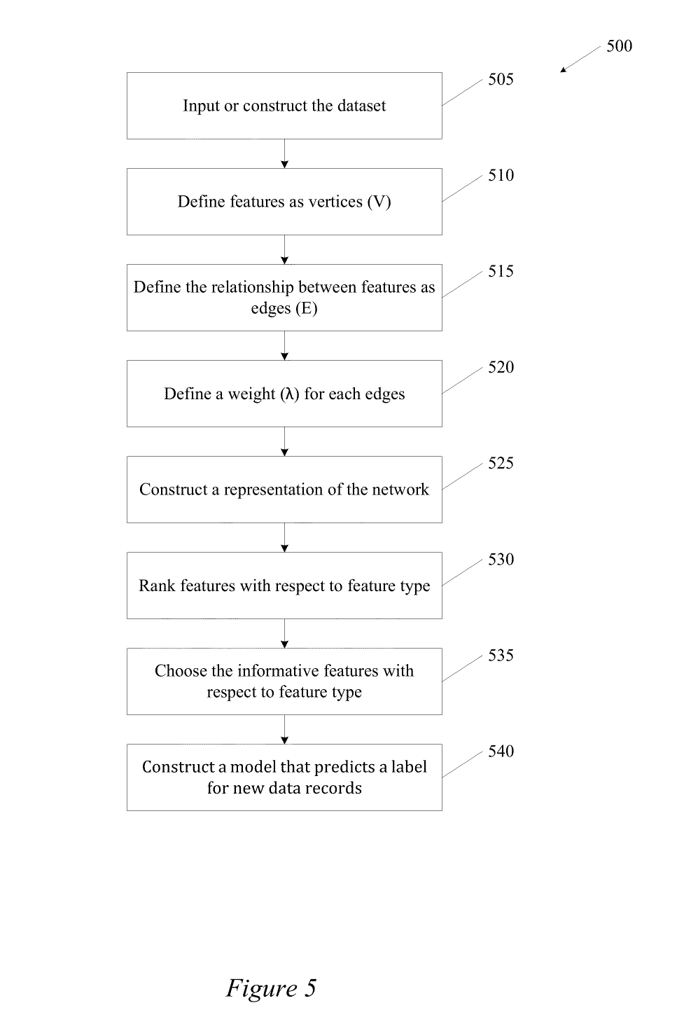

FIG. 5 is a flowchart of process 500 for developing a predictive model for feature selection according to some embodiments of the invention. Process 500 begins at block 505 where a network dataset is input into or constructed by the system. For example, the network dataset can be input from database 308 into analytics engine 310. The dataset can include, for example, the data shown in dataset 100 in FIG. 1. Various scaling and/or filtering of the data can also occur.

At block 510 features within the data set(s) are defined as vertices (V). The vertices (V) can be defined as the set of features V=X₁∪ . . . ∪Xₘ. Where, given m types of features, we can define:

$$\begin{matrix}{X}_{1} = \{ {x}_{1}^{1} , … , {x}_{1}^{n} \} \\ ⋮ \\ {X}_{m} = \{ {x}_{m}^{1} , … , {x}_{m}^{k} \} .\end{matrix}$$

In some embodiments, at block 515 the links between any two features in V can be established. These links can be labeled edges (E) and can be defined by a mathematical metric. The edges and/or this mathematical metric can define the relationship between different features. The edge between each pair of different feature types can be defined separately. In some embodiments different mathematical metrics may be used to define the relationships between each distinct pair of feature types. For example, these metrics can include the co-occurrence, correlation, Euclidan distance, or cosine similarity. In some embodiments some features can be linked differently depending on the data domain.

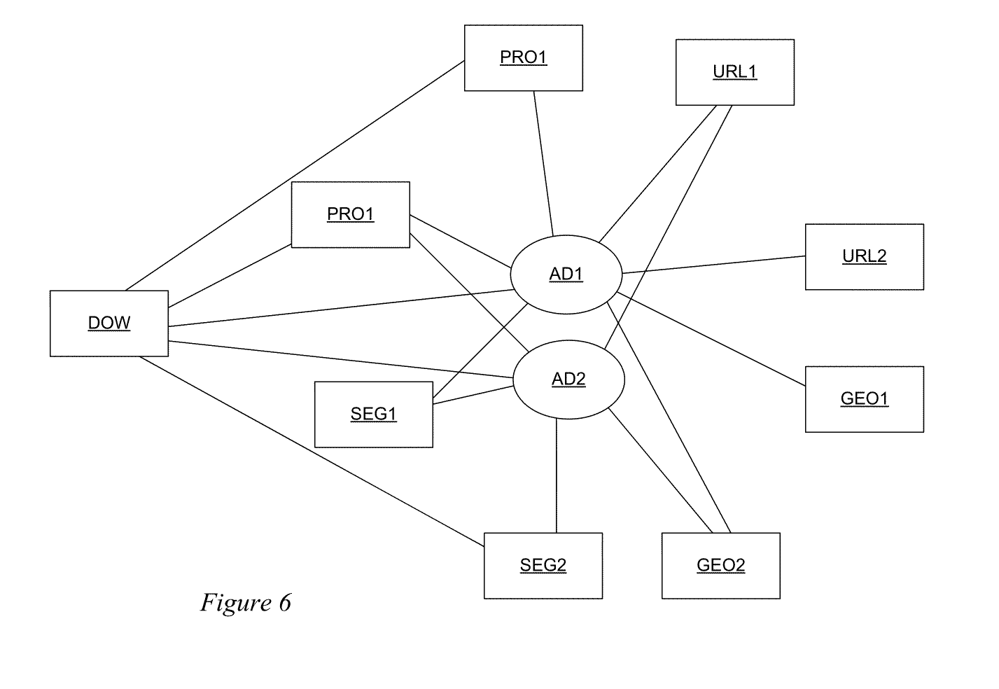

FIG. 6, shows another example of edges linked between features in a star schema. In this example, the feature “Day Of Week” is linked with some of the features shown in FIG. 2. The links may be defined in terms of labeled data, or unlabeled data.

One example of an ad-feature edge is the lift of the feature on the conversion rate. This can be determined for an advertisement, Ad, that has features, F, observed when the advertisement was in use and conversion rate, C. With these values Edge(Ad,F) [symbol] Lift(F,C|Ad)=P(C|F)/P(C). Various other metrics may also be used, such as the co-occurrence or the cosine similarity.

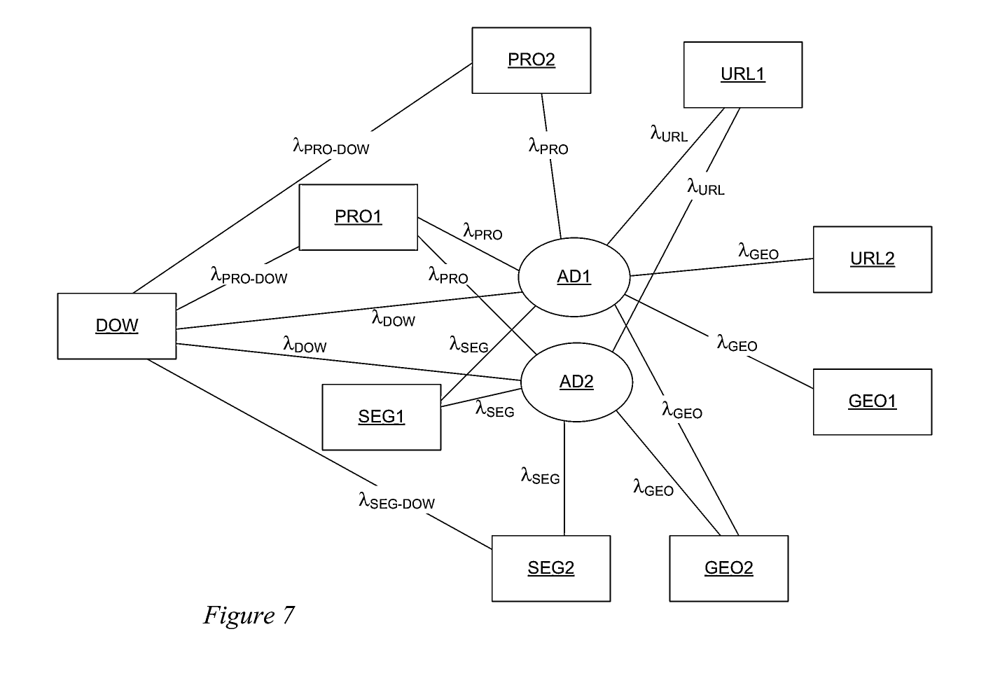

Returning to FIG. 5, at block 520 a weight for each edge can be defined according to some embodiments of the invention. The weight (λ) may represent the trustworthiness (or confidence) of each link. This trustworthiness in each relationship, can be specified with user guidance given some external knowledge about the data domain, or may be learned by optimizing for the values of λ with respect to some metric (e.g. maximizing the number of correctly labeled records with respect to the values of λ). FIG. 7 shows the arrangement of FIG. 6 with the weight, λ, shown for each edge.

Returning to FIG. 5, at block 525, a network representation can be constructed according to some embodiments of the invention. For example, a feature that exists in the dataset, but which never occurred in a record with a positive label, may be safely kept from the network, since that feature may not have useful predictive power.

At block 530, according to some embodiments of the invention, features can be ranked by feature type. By ranking the features by feature type, the features having the highest rank will be listed at the top of the feature type. For example, as shown mathematically below, information can be propagated throughout the network through an iterative process. Then upon reaching convergence, a feature ranking can be obtained for all features with respect to feature type.

For example, features can be ranked by defining the number of classes, K, based on the central feature. There can be as many classes as there are instances of the central feature. Turning to the example shown in FIGS. 2, 6 and 7, it may be reasonable to set K=|A|, where A is the set of possible advertisements. Then the information network, G, can be initialized as described in block 510, 515, and 520. This can include defining all the vertices (V), edges (E), and weights (W) and setting G=<V,E,W>.

For feature f of feature type F, its rank for class k can be represented as a probability distribution of classes over each feature: P(f|F,k), for F in V and k in 1:K. P(f|F,k) can be initialized uniformly for every feature type f. With log data, for example, F=A, P(a|A,k) is typically the identity matrix.

Once P(f|F,k) is initialized P(f|F,k)^{t} can be calculated for G^{t}. P(f|F,k)^{t+1}˜P(f|F,k)^{t}+(λ_{Y}*E(f,y)*P(y|Y,k) for all y in E(f,y), which accounts for neighborly influences. And λ_{Y} is the confidence of the edges between feature types F and Y, E(F,Y).

Using these P matrices, the network G^{t+1} can be adjusted to favor within class ranking. For example, For each k: alter W_{e,k} for all e in E based on original G⁰ and current P(f|F,k)^{t+1} until the P matrices don't change much between iteration, P(f|F,k)^{t+1}≈P(f|F,k)^{t}. This allows, for example, for the sub-network for each class to be extracted with feature rankings at a moderate extraction rate. For example, to determine that the P matrices don't change much, Σ(P(f|F,k)^{t+1}−P(f|F,k)^{t})²<ε, where ε is some convergence threshold.

At block 535 informative feature types with respect to feature type can be determined or chosen. This may be done in a number of ways. For example, informative feature types can be chosen by filtering. The filtering can be strict and/or keep only the top K features for each feature type. As another example, the filtering can be normalized to keep only the top K % of features for each feature type. As yet another example, λ-specific filtering can be used. The number of features can be scaled for each feature type based on the aggregate λ values on the edges involving the feature type. As yet another example, forward filtering can be used, where only the top ranked feature from each feature type is picked and the resulting feature set evaluated against some new labeled data. Then more features from each feature type can continue to be picked, ceasing when the performance stops improving. Backward filtering is another example, which is very similar to forward filtering, except that the entire feature set is used. Features can be iteratively removed until the performance on labeled data stops improving. Various other techniques can be used.

informative feature types with respect to feature type may also be determined by determining P(k|f,F) from P(f|F,k). Using Bayes' Rule, P(k|f,F)˜P(f|F,k)*P(k|F), where P(k|F) is the relative size of class k in type F. This can describe, for example, how well the advertisement is represented, by determining the maximum of the probability: P(k|F)=argmaxₖ(P(k|f,F)). Any maximization estimation approach can be used,

At block 540 a model can be constructed that predicts a label (or circumstance) for new data records. This model can be constructed in any number of ways. The resulting selected feature set developed above can be constructed to predict the label on any new data record. For example, a predictive model can be developed that associates each advertisement in a set of advertisements with features that produce a high probability of advertisement conversion. That is, a circumstance can be returned that specify the features (or feature types or informative feature types) that produce a high probability of advertisement conversion. Then, when a user visits a webpage an advertisement that has the highest probability for conversion can be selected from the set of advertisements using the webpage and/or user features.

In some embodiments, the rankings of the features and/or the weights of the feature types can be used to guide the predictive power of the features. For example, more highly ranked features should be correlated with a greater likelihood of advertisement conversion. And feature types can be weighted by the marketer for any reason. Then these rankings and/or weights can be used to predict which advertisement should be used at a given time on a webpage based on the user and/or webpage features.

One construction, for example, can include the following. Given P(k|x,X) for all features and all classes, a prediction for a new record can be developed. For example, suppose one would like to know the circumstances that produce a likelihood of a conversion for a given Internet advertisement. Embodiments of the invention can be used to calculate a score that represents the relative likelihood that an advertisement will result in a conversion based on the circumstances of feature type. The score vector, for example, can be constructed from [symbol] ΣP(k₁|f,F), P(k₂|f,F) . . . P(kₙ|f,F) [symbol] for all possible advertisement groups k₁, k₂, . . . , kₙ, and all categorized features, f. The advertisement that results in the maximum score vector can then be returned as the advertisement with the highest likelihood of a conversion. This can be done by using argmaxₖ of the score vector. In some embodiments, a plurality of ads can be returned that have the highest likelihood of a conversion.

In some embodiments the edge weights, λ, can be used to scale ads. For example, the contributions of feature types F can be scaled based on λ so that the total score reflects this weighting. In some embodiments, only the top ranked features are used as noted above.

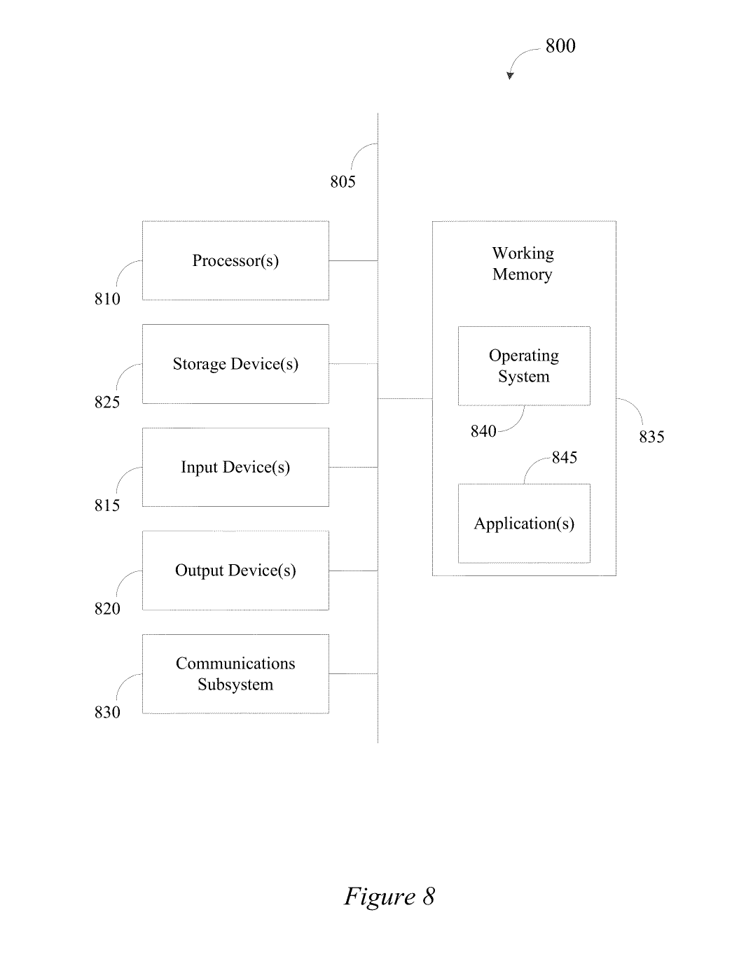

Some embodiments of the invention can be implemented using a computational system such as a server or computer system. An example of a computational system is shown in FIG. 8. For instance, user devices, web server 306, and/or analytics engine 310 can include one or more computational systems. In some embodiments multiple distributed computational systems can be geographically distributed. Moreover, method 400 and/or method 500 can be executed by one or more computational systems.

Computational system 800 includes hardware elements that can be electrically coupled via a bus 805 (or may otherwise be in communication, as appropriate). The hardware elements can include one or more processors 810, including without limitation one or more general-purpose processors and/or one or more special-purpose processors (such as digital signal processing chips, graphics acceleration chips, and/or the like); one or more input devices 815, which can include without limitation a mouse, a keyboard and/or the like; and one or more output devices 820, which can include without limitation a display device, a printer and/or the like.

The computational system 800 may further include (and/or be in communication with) one or more storage devices 825, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 800 might also include a communications subsystem 830, which can include without limitation a modem, a network card (wireless or wired), an infrared communication device, a wireless communication device and/or chipset (such as a Bluetooth device, an 802.6 device, a WiFi device, a WiMax device, cellular communication facilities, etc.), and/or the like. The communications subsystem 830 may permit data to be exchanged with a network (such as the network described below, to name one example), and/or any other devices described herein. In many embodiments, the computational system 800 will further include a working memory 835, which can include a RAM or ROM device, as described above.

The computational system 800 also can include software elements, shown as being currently located within the working memory 835, including an operating system 840 and/or other code, such as one or more application programs 845, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 825 described above.

In some cases, the storage medium might be incorporated within the computational system 800 or in communication with the computational system 800. In other embodiments, the storage medium might be separate from a computational system 800 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 800 and/or might take the form of source and/or installable code, which, upon compilation and/or installation on the computational system 800 (e.g., using any of a variety of generally available compilers, installation programs, compression/decompression utilities, etc.) then takes the form of executable code.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method comprising:
receiving a dataset of records, at least some of the records including values for a plurality of feature types and a conversion of an advertisement;
calculating, based on the received dataset of records, a mathematical metric between at least one of the plurality of feature types and the conversion of the advertisement;
ranking the values for the at least one of the plurality of feature types based on the mathematical metric;
identifying informative feature types based on the ranking of the values; and
identifying a circumstance to use the advertisement, the circumstance identified based on the circumstance comprising one or more of the informative feature types.

2. The method according to claim 1, wherein calculating the mathematical metric further comprises calculating a function between at least one of the feature types and the conversion of the advertisement, wherein the function is selected from the group consisting of a lift, co-occurrence, correlation, Euclidean distance, and cosine similarity.

3. The method according to claim 1, further comprising filtering out a plurality of feature types based on the informative feature types.

4. The method according to claim 1, wherein the feature types comprise one or more feature types selected from the list consisting of: a webpage feature type, a user feature type, and a viewing condition feature type.

5. The method according to claim 1, wherein the values comprise one or more values selected from the list consisting of: nominal values, continuous feature values, or feature values.

6. The method according to claim 1, further comprising:
defining a plurality of feature types in the dataset as vertices of a star schema and the advertisement as a central feature;
defining a plurality of edges between related feature types and the advertisement within the dataset; and
ranking values with respect to the feature types based on the plurality of edges.

7. A computing system comprising:
a processor;
a database storing a dataset of records, at least some of the records including values for feature types and a conversion of an advertisement; and
a non-transitory computer-readable medium embodying program components that configure the computing system to:
calculate a mathematical metric between at least one of the feature types and the conversion of the advertisement;
rank the values for the at least one of the feature types based on the mathematical metric;
identify informative feature types based on the ranking of the values; and
identify a circumstance to use the advertisement, the circumstance identified based on the circumstance comprising one or more the informative feature types.

8. The computing system according to claim 7, wherein the non-transitory computer-readable medium embodies program components that configure the computing system to calculate the mathematical metric by calculating a function between at least one of the feature types and the conversion of the advertisement, wherein the function is selected from the group consisting of the lift, co-occurrence, correlation, Euclidan distance, and cosine similarity.

9. The computing system according to claim 7, wherein the non-transitory computer-readable medium embodies program components that configure the computing system to filter out a plurality of feature types based on the values.

10. The computing system according to claim 7, wherein the non-transitory computer-readable medium embodies program components that configure the computing system to:
define a plurality of feature types in the dataset as vertices of a star schema and at least one feature type as the central feature;
define a plurality of edges between related feature types within the dataset; and
rank values with respect to feature type based on the edges.

11. A method comprising:
receiving a dataset of records, at least some of the records including values for a plurality of feature types and a conversion of an advertisement;
defining a plurality of feature types in the dataset as vertices of a star schema and at least one feature type as a central feature;
defining a plurality of edges between related feature types within the dataset;
ranking the values with respect to feature type based on the edges; and
providing a model that correlates the probability of the central feature based on the ranking.

12. The method according to claim 11, wherein the central feature comprises an advertisement and wherein at least one feature is the conversion rate of the advertisement.

13. The method according to claim 12, wherein at least one edge of the plurality of edges between the advertisement and the conversion rate is the lift.

14. The method according to claim 11, further comprising filtering out a plurality of values of a given feature type.

15. The method according to claim 11, further comprising determining a weight of one or more of the plurality of edges and filtering feature types based on the weight of the edge.

16. A computer program product comprising a non-transitory computer-readable medium embodying code executable by a computing system, the code comprising:
program code that receives a dataset of records, at least some of the records including values for feature types and a conversion of an advertisement;
program code that defines a plurality of the features types as vertices of a star schema and the advertisement as a central feature;
program code that defines a plurality of edges between the features types and the central feature;
program code that ranks the values with respect to a feature type based on the edges; and
program code that provides a model that correlates a probability of the central feature existing based on the vertices of the star schema using the ranking.

17. The computer program product set forth in claim 16, wherein an edge between the advertisement and the conversion is the lift.

18. The computer program product set forth in claim 16, further comprising program code that filters out a plurality of values of a given feature type.

19. The computer program product set forth in claim 16, further comprising program code to determine a weight of each edge and program code to filter values based on the weight of the edge.
